(19) United States
(12) Patent Application Publication
(10) Pub. No.: US 2024/0339680 A1
(43) Pub. Date: Oct. 10, 2024

(54) Communication between a power tool and a rechargeable battery

(71) Applicant: Hilti Aktiengesellschaft, Schaan (LI)

(72) Inventors: Stefan MAYER, Hurlach (DE); Klaus HAUSER, Schwabmuenchen (DE); David KOSCHECK, Landsberg (DE)

(21) Appl. No.: 18/579,402

(22) PCT Filed: Jul. 7, 2022
(86) PCT No.: PCT/EP2022/068819

§ 371 Date: Jan. 15, 2024

(30) Foreign Application Priority Data
Jul. 20, 2021 (EP) 21186591.0

(51) Int. Cl. H01M 10/42; B25F 5/00

(52) U.S. Cl. CPC H01M 10/425; B25F 5/00; H01M 2010/4278; H01M 2220/30

(57) ABSTRACT

Method for communication between a power tool and a rechargeable battery, wherein the rechargeable battery includes a controller unit having a first transceiver, and the power tool includes a control unit having a second transceiver. The method involves the method steps of emitting a first signal from the first to the second transceiver; emitting a second signal from the first to the second transceiver after a predetermined period of time has elapsed; shifting the power tool from a first operating state into a second operating state if the number of received signals in a predetermined period of time reaches a predetermined threshold value, and/or emitting a signal to the first transceiver in order to shift the rechargeable battery from a first operating state into a second operating state if the number of received signals in a predetermined period of time reaches a predetermined threshold value. System for performing the method for communication, including a power tool and rechargeable battery. Rechargeable battery for performing the method for communication. Power tool for performing the method for communication.

The present invention relates to a method for communication between a power tool and a rechargeable battery for supplying the power tool with electrical energy, wherein the rechargeable battery comprises a controller unit having at least one first transceiver, and the power tool comprises a control unit having at least one second transceiver.

The present invention also relates to a system for performing the method for communication, comprising a power tool and a rechargeable battery.

In addition, the present invention relates to a rechargeable battery for performing the method for communication.

The present invention further relates to a power tool for performing the method for communication.

### BACKGROUND

For supplying an electrically operated power tool with electrical energy, a rechargeable battery is often releasably connected to the power tool so that the energy storage cells (also known as battery cells) arranged inside the rechargeable battery can deliver stored electrical energy to relevant loads of the power tool. The loads may be the drive for the power tool, a lamp, a controller apparatus or the like. An apparatus for a connection of this type between the power tool and the rechargeable battery consists of both mechanical attachment components and electrical connecting terminals. A connection apparatus of this type is often also referred to as an interface or interface apparatus.

The electrical connecting terminals are provided usually as releasable plug-in connections in the respective positive and negative paths of the electrical energy supply so that the positive and negative contacts of the rechargeable battery are thereby in contact with the corresponding positive and negative contacts of the loads of the power tool.

The mechanical components may be in the form of a rail system or a plug-in connection, for example, by means of which it is possible to slide the rechargeable battery onto the connection apparatus on the power tool, which connection apparatus is embodied as an interface, and also to remove said rechargeable battery again. Sliding the rechargeable battery onto the power tool causes the connecting terminals (i.e. positive and negative contacts) of the rechargeable battery to connect to the corresponding connecting terminals of the power tool, so that the electrical energy stored in the rechargeable battery can reach the loads of the power tool.

### SUMMARY OF THE INVENTION

An exact and, above all, firm connection between the power tool and the rechargeable battery often presents a certain challenge.

On the one hand, the mechanical components and electrical connecting terminals must be designed to ensure relatively simple handling so that attaching the rechargeable battery to the power tool, and also removing it, is as straightforward as possible.

On the other hand, the mechanical components and electrical connecting terminals must be relatively robust so that they can withstand the movements, vibrations and impacts during use of the power tool with the connected rechargeable battery.

Even a brief or temporary interruption in the connection between the power tool and the rechargeable battery is always undesirable.

An interruption in the connection can lead to an intermittent supply of electrical energy to the power tool from the rechargeable battery, with the result that the electric motor of the power tool no longer rotates steadily and/or rotates only at a lower speed. This can lead in turn, for example, to power fluctuations at the electric motor, causing the electric motor to generate an unsteady torque or merely too low a torque. Fluctuations in power or rotational speed that generate a lower torque output from the electric motor ultimately lead to the power tool working inefficiently.

In addition, an interruption of this type in the energy supply can also indicate a malfunction of the rechargeable battery. It is always necessary to pay attention to malfunctions of the rechargeable battery, as these may ultimately lead to complete breakdown or total failure of the rechargeable battery.

Moreover, an interruption in the connection can also indicate imminent failure of the mechanical components of the connection apparatus. In the event of the mechanical components failing, the rechargeable battery may separate from the power tool and fall to the ground, which can result in permanent damage to the rechargeable battery.

The problem in this regard is that an initial or incipient detachment or separation of the rechargeable battery from the power tool often remains unnoticed until finally the rechargeable battery has suddenly fallen and thus failure or permanent damage to the rechargeable battery has occurred.

One aim of the present invention is therefore to detect as early as possible the presence of a fault in the connection between the power tool and the rechargeable battery that can ultimately cause the rechargeable battery to disconnect from the power tool, and also to take appropriate action.

It is an object of the present invention to provide a method for bidirectional communication between a power tool and a rechargeable battery, which method can be used to solve the aforementioned problem and, in particular, to indicate a faulty attachment of the rechargeable battery to the power tool.

The present invention provides a method for communication between a power tool and a rechargeable battery for supplying the power tool with electrical energy, wherein the rechargeable battery comprises a controller unit having at least one first transceiver, and the power tool comprises a control unit having at least one second transceiver.

According to the invention, the method comprises the method steps of
emitting at least one first signal from the first transceiver to the second transceiver;
emitting at least one second signal from the first transceiver to the second transceiver after a predetermined period of time has elapsed;
shifting the power tool from a first operating state into a second operating state if the number of signals received by the second transceiver in a predetermined period of time reaches a predetermined threshold value and/or the form of the signal received by the second transceiver deviates from a predetermined form according to a predetermined threshold value, and/or
emitting at least one signal from the second transceiver to the first transceiver in order to shift the rechargeable battery from a first operating state into a second operating state if the number of signals received by the second transceiver in a predetermined period of time reaches a predetermined threshold value and/or the form of the signal received by the second transceiver deviates from a predetermined form according to a predetermined threshold value.

The first operating state may be an activation mode of the power tool or of the rechargeable battery, in which at least one function of the power tool or of the rechargeable battery is in an activated state. The at least one function of the power tool may be running a drive of the power tool in order to generate a torque. In addition, the at least one function of the rechargeable battery may be providing the electrical energy stored in the rechargeable battery. The second operating state may be a deactivation state, in which all the functions of the power tool or of the rechargeable battery are in a deactivated state. The deactivation of all the functions of the power tool means that, for instance, the drive of the power tool for generating a torque also stops running, at least temporarily. The deactivation of all the functions of the rechargeable battery leads to an at least temporary interruption in providing the electrical energy stored in the rechargeable battery.

The form of the signal may involve one or more attributes of the communication signal. The attributes of the communication signal may be a voltage level, a current level, the voltage edge(s), a voltage drop, a voltage rise, a number of bits or the like.

The communication between the power tool and the rechargeable battery may be bidirectional communication or else monodirectional or unidirectional communication. In the case of bidirectional communication, it is possible to exchange signals, data and information between the power tool and the rechargeable battery. In the case of monodirectional or unidirectional communication, in contrast, signals, data and information are sent solely from the rechargeable battery to the power tool, or from the power tool to the rechargeable battery.

According to an advantageous embodiment of the present invention, it may be possible that there is included the method step of:
emitting a signal containing a synchronization pattern from the first transceiver to the second transceiver in order to adjust the transmission rate for the communication between the at least one first transceiver and second transceiver.

The transmission rate for the communication between the at least one first transceiver and second transceiver can also be referred to as the “baud rate”.

The present invention also provides a system for performing the method for communication, comprising a power tool and a rechargeable battery for supplying the power tool with electrical energy, wherein the rechargeable battery comprises at least one first transceiver, and the power tool comprises at least one second transceiver, and wherein the rechargeable battery comprises a first communication element, and the power tool comprises a second communication element, which can be connected to the first communication element, wherein in a connected state, signals can be transferred between the first and second communication elements.

Rechargeable battery for performing the method for communication, comprising a controller unit having at least one first transceiver.

Power tool for performing the method for communication, comprising a control unit having at least one second transceiver.

### BRIEF DESCRIPTION OF THE DRAWINGS

Further advantages will become apparent from the following description of the figures. Various exemplary embodiments of the present invention are illustrated in the figures. The figures, the description and the claims contain numerous features in combination. A person skilled in the art will expediently also consider the features individually and combine them to form useful further combinations.

Identical and similar components are denoted by the same reference signs in the figures, in which:

FIG. 1 shows a schematic side view of a system according to the invention having a power tool and a rechargeable battery, which is connected to the power tool.

FIG. 2a shows a perspective view of the rechargeable battery having a rechargeable-battery interface;

FIG. 2b shows a perspective view of the power tool having a power-tool interface; and

FIG. 3 shows a perspective view of a handle together with a base apparatus of the power tool, and of the rechargeable battery having the rechargeable-battery interface.

### DETAILED DESCRIPTION

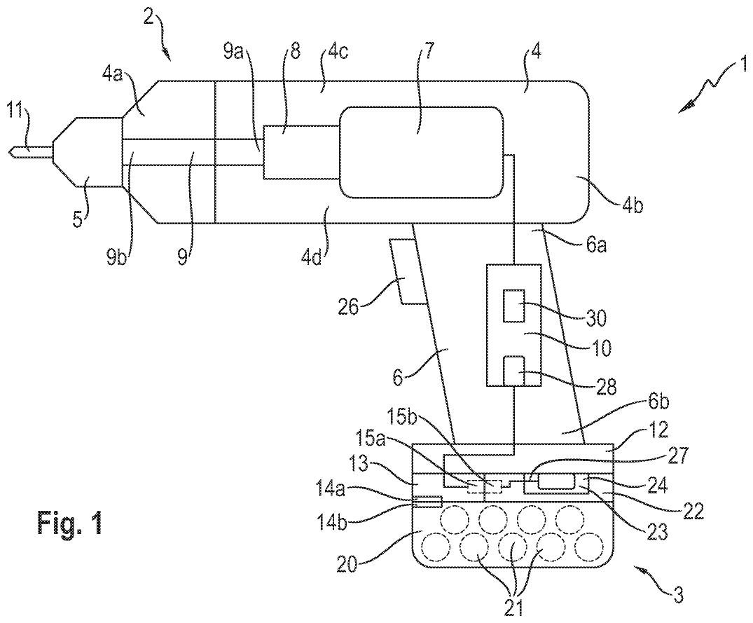

FIG. 1 shows a preferred exemplary embodiment of a system 1 according to the invention having a power tool 2 and a rechargeable battery 3.

In the present exemplary embodiment, the power tool 2 is in the form of a rechargeable battery-operated screwdriver. According to an alternative embodiment, the power tool 2 may also be in the form of a power drill, a saw, a sander or the like.

The power tool 2 mainly comprises a housing 4, a tool fitting 5 and a handle 6.

The housing 4 of the power tool 2 in turn comprises a front end 4a, a rear end 4b, a top side 4c and an underside 4d. As FIG. 1 indicates, positioned inside the housing 4 is a drive 7, a transmission apparatus 8, an output shaft 9 and a control unit 10. The drive 7 is in this case in the form of a brushless electric motor. As an alternative, the drive 7 can also be in the form of an electrical motor that uses carbon-brush commutation.

The drive 7 in the form of a brushless electric motor serves to generate a torque. The drive 7 is connected to the transmission apparatus 8 in such a way that the torque generated by the drive 7 is transferred to the transmission apparatus 8. The output shaft 9 comprises a first end 9a and a second end 9b. The transmission apparatus 8 is in turn connected to the first end 9a of the output shaft 9 so that the torque generated by the drive 7 is transferred to the output shaft 9. The second end 9b of the output shaft 9 is connected to the tool fitting 5 in such a way that the torque of the output shaft 9 is transferred to the tool fitting 5. The tool fitting 5 serves to receive and hold a tool 11. In the present exemplary embodiment, the tool 11 is in the form of a screwdriver bit. By means of the torque transferred to the tool fitting 5, the torque is finally transferred to the tool 11 in the form of a screwdriver bit.

The handle 6 comprises a first end 6a and a second end 6b, and is used by a user to hold and guide the power tool 2. The user is not illustrated in the figures. Positioned on one side of the handle 6 is a switch for activating the power tool. The first end 6a of the handle 6 is arranged on the underside 4d of the housing 4. A base apparatus 12 is connected at the second end 6b of the handle 6. At the base apparatus 12 is contained a power-tool interface 13. The power-tool interface 13 serves as the connection for the rechargeable battery 3.

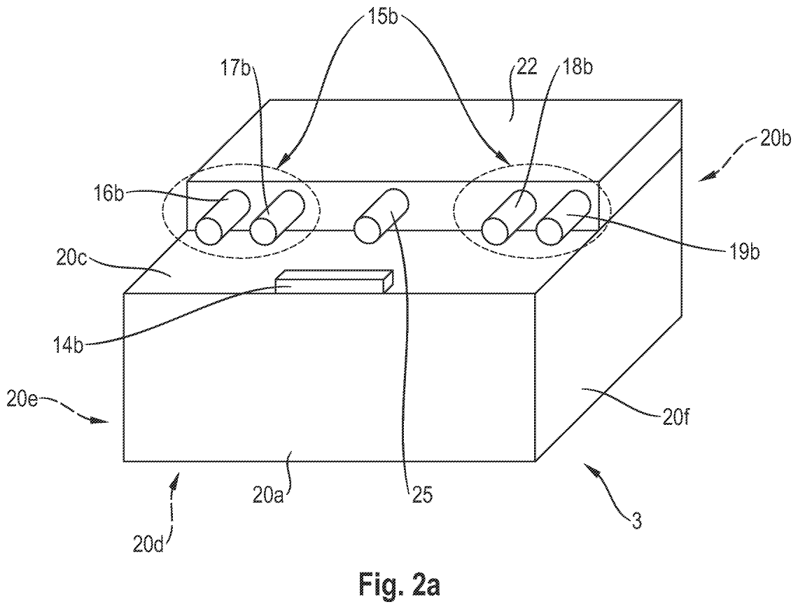

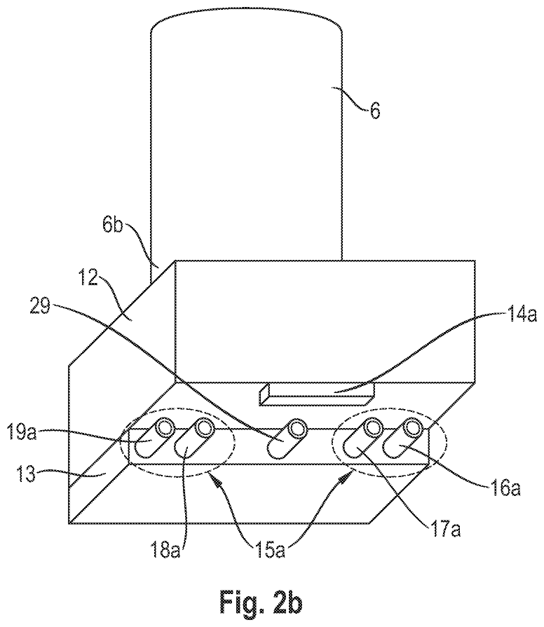

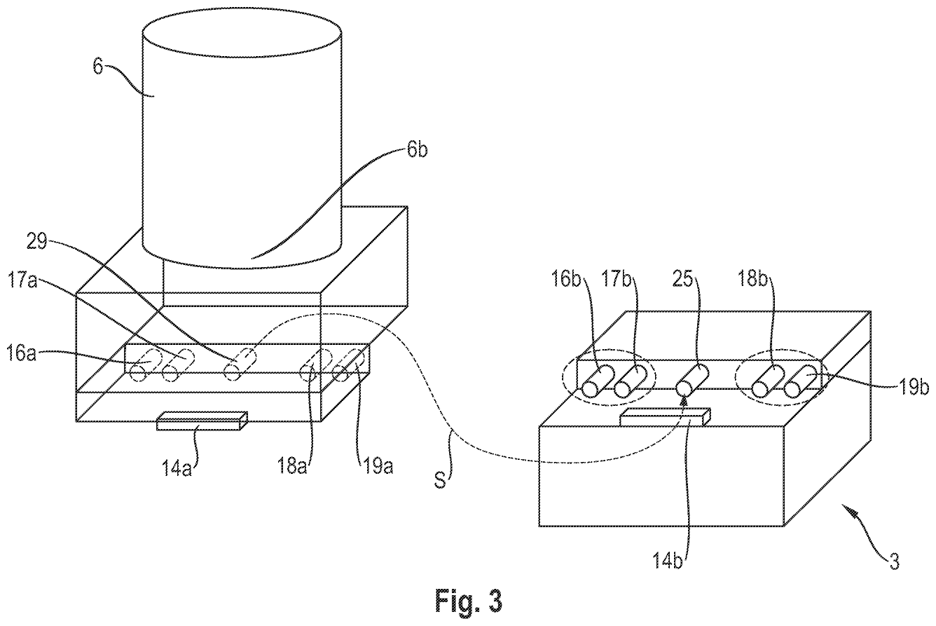

As can be seen in FIGS. 2a, 2b and 3, the power-tool interface 13 comprises a mechanical attachment component 14a and electrical connecting terminals 15a. The mechanical attachment component 14a of the power-tool interface 13 is here in the form of a locking element. The electrical connecting terminals 15a of the power-tool interface 13 are in turn in the form of first and second positive contacts 16a, 17a and first and second negative contacts 18a, 19a.

According to an alternative exemplary embodiment, just one positive contact and one negative contact may be provided. According to a further alternative exemplary embodiment, three positive contacts and three negative contacts may be provided.

FIG. 2a depicts the rechargeable battery 3. The rechargeable battery 3 comprises a battery housing 20, a number of energy storage cells 21, a rechargeable-battery interface 22 and a controller unit 23 (See FIG. 1).

Positioned inside the battery housing 20 are the energy storage cells 21 and the controller unit 23.

The battery housing 20 comprises a front side 20a, a rear side 20b, a top side 20c, an underside 20d, a left-hand side wall 20e and a right-hand side wall 20f. Positioned on the top side 20c is the rechargeable-battery interface 22. Only the right-hand side wall 20f is depicted in FIGS. 2 and 3. The left-hand side wall 20e, see FIG. 2a, is identical in design to the right-hand side wall 20f, however.

The rechargeable-battery interface 22 is designed to correspond to the power-tool interface 13, so that the rechargeable-battery interface 22 and the power-tool interface 13 can be releasably connected to one another. The rechargeable-battery interface 22 comprises for this purpose likewise a mechanical attachment component 14b and electrical connecting terminals 15b (see FIG. 1).

The electrical connecting terminals 15b of the rechargeable-battery interface 22 are in turn in the form of first and second positive contacts 16b, 17b and first and second negative contacts 18b, 19b.

Just as for the power-tool interface 13, the mechanical attachment component 14b is in the form of a locking element.

The locking element of the rechargeable-battery interface 22 corresponds to the locking element of the power-tool interface 13, so that the two locking elements can be releasably connected to one another in an interlocking manner. As an alternative, the connection of the two locking elements can also have a force-locking design.

According to an alternative embodiment, the mechanical attachment component at the power-tool interface 13, and correspondingly at the rechargeable-battery interface 22, can also be in the form of a rail apparatus for a releasable interlocking attachment of the rechargeable battery 3 to the power tool 2.

Furthermore, the rechargeable battery 3 comprises a first transceiver 24 and a first communication element 25.

As FIG. 1 indicates, the first transceiver 24 is positioned at the controller unit 23 of the rechargeable battery 3. According to an alternative embodiment, the first transceiver 24 may also be positioned at another point on the rechargeable battery 3, and be connected by a first line to the controller unit 23 for the purpose of exchanging signals and data.

As FIG. 1 also shows, according to a first exemplary embodiment of the present invention, the first communication element 25 is in the form of a male connector. The first communication element 25, which is in the form of a male connector, is in turn connected via a first communication line 27 to the controller unit 23. By connecting the first communication element 25 to the controller 23, signals, data and information can be exchanged.

The first communication element 25 serves mainly to emit and receive communication signals respectively from and to the rechargeable battery 3. As depicted in FIGS. 2a and 3, the first communication element 25, which is in the form of a male connector, is positioned at the rechargeable-battery interface 22 between the positive contacts and negative contacts 16b, 17b, 18b, 19b.

According to a further exemplary embodiment, the first communication element 25 may also be in the form of a radio element for wireless communication or radio transmission.

The power tool 2 comprises correspondingly a second transceiver 28 and a second communication element 29.

As FIG. 1 also indicates, the second transceiver 28 is positioned at the control unit 10 of the power tool 2. According to an alternative embodiment, the second transceiver 28 may also be positioned at another point on the power tool 2, and be connected by a second line to the control unit 10 for the purpose of exchanging signals and data.

As FIG. 3 likewise indicates, according to the first exemplary embodiment of the present invention, the second communication element 29 is in the form of a female connector. The second communication element 29, which is in the form of a female connector, corresponds to the first communication element 25, which is in the form of a male connector, so that the first communication element 25, which is in the form of a male connector, can make a plug-in connection to the second communication element 29, which is in the form of a female connector. By connecting the first communication element 25 to the second communication element 29, signals, data and information can be exchanged or communicated between the controller unit 23 of the rechargeable battery 3 and the control unit 10 of the power tool 2. The communication between the power tool 2 and the rechargeable battery 3 may be either bidirectional communication or else unidirectional or monodirectional communication. In the case of unidirectional or monodirectional communication, only signals, data and information are sent from the controller unit 23 of the rechargeable battery 3 to the control unit 10 of the power tool 2.

As FIGS. 2b and 3 indicate, the second communication element 29, which is in the form of a female connector, is positioned at the power-tool interface 13 between the positive contacts and negative contacts 16a, 17a, 18a, 19a.

According to a further exemplary embodiment, the second communication element 29 may also be in the form of a radio element for wireless communication or radio transmission.

For the exemplary embodiment in which both the first and the second communication elements 25, 29 are in the form of a radio element for wireless communication or radio transmission, the exchange of signals, data and information from the controller unit 23 of the rechargeable battery 3 to the control unit 10 of the power tool 2 takes place in the form of a radio link. The radio link may be Bluetooth, WLAN, ZigBee, NFC (near field communication), Wibree or WIMAX in the radio frequency band and also IrDA (infrared data association), FSO (free-space optical communication) and Li-Fi (light fidelity) in the infrared and optical frequency bands.

FIG. 1 shows the system 1 with the power tool 2 and the rechargeable battery 3 in a connected state, in which the rechargeable battery 3 as the energy supply is releasably connected through the power-tool interface 13 to the rechargeable-battery interface 22 of the power tool 2. As can be seen in FIG. 3, the power tool 2 follows the dashed line S for this purpose. In this state, both the respective positive contacts and negative contacts 16a, 17a, 18a, 19a, 16b, 17b, 18b, 19b and the first and second communication elements 25, 29 are connected to one another. If both the power tool 2 and the rechargeable battery 3 are in an activation mode (also an activation state or operating state), electrical energy from the rechargeable battery 3 can reach the power tool 2, for instance as a function of the rechargeable battery 3. Furthermore, for instance as a function of the power tool 2, the drive 7 in the form of an electric motor can rotate and thereby generate a torque.

A communication method between the power tool 2 and the rechargeable battery 3 serves to ensure that the rechargeable battery 3 continues to be connected firmly and properly to the power tool 2 also while the system 1 is in use. By means of the communication method, it is possible to detect a possible malfunction of the rechargeable battery 3, for example as a result of a faulty or damaged fastening of the rechargeable battery 3 to the power tool 2.

In order to perform the method, the power tool 2 and the rechargeable battery 3 are in a connected state, so that the respective mechanical attachment components 14a, 14b, electrical connecting terminals 15a, 15b and the communication elements 25, 29 are connected to one another; cf. FIG. 1 or 3. By means of the controller unit 23 of the rechargeable battery 3, a signal is generated and sent at regular time intervals via the first communication element 25 of the rechargeable battery 3 to the second communication element 29 of the power tool 2. The signal is then sent from the second communication element 29 to the control unit 10 of the power tool 2.

Emitting signals at regular time intervals means in this context that a certain transmission rate (or frequency) is selected for the emission of the signals, which is transferred to the power tool 2 (or to the control unit 10 of the power tool 2) initially, i.e. immediately after the rechargeable battery 3 is connected to the power tool 2. In addition, the power tool 2 is notified of the form of the signal and further attributes of the signal communication. The form of the sent signal, and the further attributes of the signal communication, can be saved in a memory 30 of the control unit 10 of the power tool 2.

The emitted signal can be characterized in this context by the “waveform”. The “waveform” of a signal or a series of signals describes the character and shape of the variation over time of an oscillation quantity. The character or shape may be sinusoidal, square-wave, triangular, sawtooth or the like.

Furthermore, the emitted signal may be characterized by, for example, a voltage level, a current level, the voltage edge(s), a voltage drop, a voltage rise, a number of bits or the like.

In the event that the emitted signal is in the form of bits, a certain transmission rate (also known as a baud rate) is also defined for this purpose.

In the present exemplary embodiment, the emitted signal is characterized by a voltage level of 5 mV.

In the event that the predetermined form and frequency of the signals emitted by the rechargeable battery 3 and received by the power tool 2 are practically unchanged, both the power tool 2 and the rechargeable battery remain in an existing operating state (also known as mode or operating mode). Thus, for instance, the power tool 2 may remain in an activation state in which the drive 7 in the form of an electric motor generates a torque. The rechargeable battery 3 likewise remains in an activation state in which electrical energy from the rechargeable battery 3 continues to reach the power tool 2.

If, for instance as a result of the system 1 being dropped or being otherwise handled incorrectly, the rechargeable battery 3 is no longer connected properly to the power tool 2 and hence the communication connection between the rechargeable battery 3 and the power tool 2 is impaired, the signals are no longer transferred in the predetermined form and at the predetermined frequency (or transmission rate or baud rate). Since the predetermined form and transfer rate of the signals were saved in the control device 10 of the power tool 2 before the communication started, any deviation or alteration in the form and transfer rate of the received signals can be identified by the control device 10. As result of an identified deviation or alteration, the power tool 2 is changed from the activation state into a deactivation state by means of the control device 10.

It should be noted here that for the activation state to change into the deactivation state, there must be a sufficiently large deviation in the form and transfer rate of the received signals. For this purpose, appropriate threshold values for the deviation are saved in the control device 10 of the power tool 2. In the event that either the form or the transfer rate of the received signals reaches a stored threshold value, the control device causes a change in the operating state of the power tool 2.

### LIST OF REFERENCE SIGNS

1 system
2 power tool
3 rechargeable battery
4 housing of the power tool
4a front end of the housing of the power tool
4b rear end of the housing of the power tool
4c top side of the housing of the power tool
4d underside of the housing of the power tool
5 tool fitting
6 handle
6a first end of the handle
6b second end of the handle
7 drive
8 transmission apparatus
9 output shaft
9a first end of the output shaft
9b second end of the output shaft
10 control unit
11 tool
12 base apparatus
13 power-tool interface
14a mechanical attachment component of the power-tool interface
14b mechanical attachment component of the rechargeable-battery interface
15a electrical connecting terminals of the power-tool interface
15b electrical connecting terminals of the rechargeable-battery interface
16a first positive contact of the electrical connecting terminals of the power-tool interface
16b first positive contact of the electrical connecting terminals of the rechargeable-battery interface
17a second positive contact of the electrical connecting terminals of the power-tool interface
17b second positive contact of the electrical connecting terminals of the rechargeable-battery interface
18a first negative contact of the electrical connecting terminals of the power-tool interface
18b first negative contact of the electrical connecting terminals of the rechargeable-battery interface
19a second negative contact of the electrical connecting terminals of the power-tool interface
19b second negative contact of the electrical connecting terminals of the rechargeable-battery interface
20 battery housing
20a front side of the battery housing
20b rear side of the battery housing
20c top side of the battery housing
20d underside of the battery housing
20e left-hand side wall of the battery housing
20f right-hand side wall of the battery housing
21 energy storage cells
22 rechargeable-battery interface
23 controller unit
24 first transceiver
25 first communication element
26 switch
27 first communication line
28 second transceiver
29 second communication element
30 memory
S line for connecting the power tool to the rechargeable battery

What is claimed is:

1-5. (canceled)

6. A method for communication between a power tool and a rechargeable battery for supplying the power tool with electrical energy, the rechargeable battery including a controller unit having at least one first transceiver, and the power tool including a control unit having at least one second transceiver, the method steps of:
emitting at least one first signal from the first transceiver to the second transceiver;
emitting at least one second signal from the first transceiver to the second transceiver after a predetermined period of time has elapsed;
shifting the power tool from a first operating state into a second operating state if a number of signals received by the second transceiver in a predetermined period of time reaches a predetermined threshold value or a form of the signal received by the second transceiver deviates from a predetermined form according to a predetermined threshold value; and
emitting at least one signal from the second transceiver to the first transceiver in order to shift the rechargeable battery from a first operating state into a second operating state if the number of signals received by the second transceiver in a predetermined period of time reaches a predetermined threshold value and/or the form of the signal received by the second transceiver deviates from a predetermined form according to a predetermined threshold value.

7. The method as recited in claim 6 further comprising emitting a signal containing a synchronization pattern from the first transceiver to the second transceiver in order to adjust a transmission rate for the communication between the at least one first transceiver and second transceiver.

8. A system for performing the method as recited in claim 6, the system comprising:
the power tool; and
the rechargeable battery including a first communication element, and
the power tool including a second communication element connectable to the first communication element, wherein in a connected state, signals are transferrable between the first and second communication elements.

9. A rechargeable battery for performing the method as recited in claim 6.

10. A power tool for performing the method for performing the method as recited in claim 6.
